(19) United States
(12) Patent Application Publication
(10) Pub. No.: US 2009/0003918 A1
(43) Pub. Date: Jan. 1, 2009

(54) Article Having a Grip Zone Which Serves for Handling

(75) Inventors: Udo Beck, Nurnberg (DE); Walter Oetter, Stein (DE); Gerhard Lugert, Nurnberg (DE)

Correspondence Address: LERNER GREENBERG STEMER LLP, P O BOX 2480, HOLLYWOOD, FL, 33022-2480, US

(73) Assignee: FABER-CASTELL AG, Stein (DE)

(21) Appl. No.: 12/145,937

(22) Filed: Jun. 25, 2008

(30) Foreign Application Priority Data
Jun. 26, 2007 (EP) 07 012 464.9

(51) Int. Cl. B43K 23/008

(52) U.S. Cl. 401/6

(57) ABSTRACT

An article, more particularly a pencil-like writing implement has a grip zone which serves for handling. At least part of the grip zone bears individual silicone rubber structures formed as separate parts and project from a surface of the grip zone. Ideally the structures are soft, have good tactility and grip, and adhere well to a multiplicity of different materials.

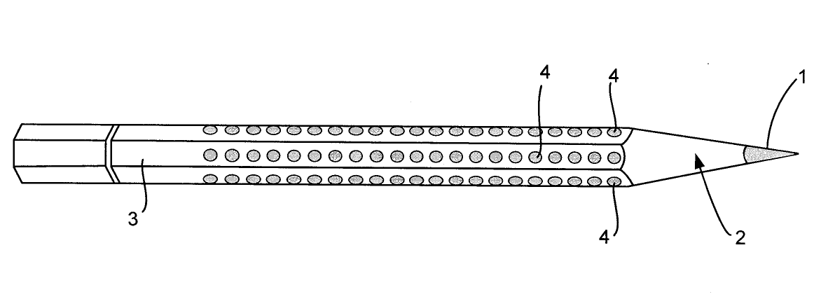

### CROSS REFERENCE TO RELATED APPLICATION

This application claims the priority, under 35 U.S.C. § 119, of European application EP 07 012 464.9, filed Jun. 26, 2007; the prior application is herewith incorporated by reference in its entirety.

### BACKGROUND OF THE INVENTION

### Field of the Invention

The invention relates to an article, more particularly a pencillike writing implement having a grip zone which serves for handling, at least part of the grip zone bearing individual structures which project from the surface of the grip zone. Pencillike writing implements of this kind are known from European patent EP 1 177 108, corresponding to U.S. Pat. No. 6,461,067, for example. Raised structures are generated on a wood-encased pencil by applying an aqueous polymer dispersion to the surface of the pencil. On a wood substrate and on specific coatings, adhesion is sufficiently firm. With plastic-encased pencils or writing implements with plastic shafts, the aqueous solvent results in many cases where it is not possible to achieve firm adhesion of the structures. In that case it is necessary to fall back on structures made from other materials—for example, based on coating materials containing organic solvents, or on thermoplastics and the like; even here, adhesion cannot be achieved on all materials, such as wood, various coatings, and plastics such as ABS, PP, and PVC, that are typical for the manufacture of writing implements or other articles such as tennis racquets, hammer shafts, and the like. In the context of the manufacture of a wide diversity of different articles that are to be provided with projecting structures, as is the case more particularly in the writing implement industry, therefore, it is necessary when selecting the material for the structures to be governed by the respective material of which the articles are made—this entails different stock holdings and different application methods. For example, the manufacture of articles having structures based on aqueous polymer dispersions requires a completely different technical procedure than is the case with structures based on thermoplastics or on solvent-born coating materials. In the case of solvent-born coating materials at least a relatively long drying phase is needed, during which there is a risk that the as yet uncured structures will run or be changed in some other way. European patent EP 1 514 700, corresponding to U.S. Pat. No. 6,837,637, discloses wood-encased pencils with raised structures of radiation-curable plastics applied to their surface. Although the compositions are initially still fluid, their solidification is relatively quick, and so there is no risk of the structures—pimplelike structures, for example—running. However, it is a disadvantage that the materials disclosed in the cited publication are not optimum in terms of their tactility and grip. This, however, is not to exhaust the problems associated with the manufacture of articles having grip zones of the type referred to at the outset. In addition to the requirement that the projecting structures must be soft and grippy and ought overall to have a tactility that is pleasing to the user, the structures must not have a sticky feel, particularly on exposure to perspiration from the hand. As well as the respective adhesion conditions to be taken into account as a result of the different materials, therefore, there are also the specific properties of the material to be taken into account, in respect more particularly of tactility and grip. Consequently the production of raised structures on a grip zone of an article in each case necessitates considerable adaptations of the fabricating operation.

### SUMMARY OF THE INVENTION

It is accordingly an object of the invention to provide an article having a grip zone which serves for handling which overcomes the above-mentioned disadvantages of the prior art devices of this general type, wherein the structures are soft, have good tactility and grip, and adhere well to a multiplicity of different materials.

The object is achieved by an article, more particularly by a pencil like writing implement wherein at least part of the grip zone, which serves for handling, bears individual silicone rubber structures formed as separate parts and project from a surface of the grip zone. The projecting structures, in other words, are not joined as one piece with the material that forms the grip zone of the article.

Structures of this kind are soft, are pleasant to touch, and offer high slip resistance and grip. They can be applied with good adhesion to a wide multiplicity of different materials; as a result of this, when producing articles having grip zones formed from different materials, it is possible in each case to employ the same application methods, examples being application of drops, each forming individual structures, by nozzles, or else spray application or screen printing. The selection of a suitable application method can be made independently of the material of which the article is made; consequently, more particularly in the context of the production of writing implements, use of silicone rubber structures is universal for any product versions such as, for example, sharpenable, wood-clad or plastic-clad pencils, pencil crayons, and cosmetic pencils, ballpoint pens, ballpoint ink pens, markers, gel pens, and mechanical pencils. Examples of common materials for the stated pencils, crayons or other articles are ABS polymers, polypropylene, polycarbonate, PVC, and polystyrene.

In accordance with an added feature of the invention, the individual silicone rubber structures are composed of a UV-crosslinked silicone rubber.

In accordance with another feature of the invention, the individual silicone rubber structures are composed of a silicone rubber crosslinked with oxysilane.

In accordance with an additional feature of the invention, the silicone rubber contains polydimethylsiloxane crosslinked via acetoxysilane.

In accordance with a further feature of the invention, the individual silicone rubber structures are composed of a silicone rubber crosslinked with oximosilane. Ideally, the silicone rubber contains polydimethylsiloxane crosslinked via butan-2-one oxime.

In accordance with another added feature of the invention, the individual silicone rubber structures are formed from crude silicone rubber dispersions. The silicone rubber dispersions can be peroxide-crosslinking crude silicone rubber or platinum-crosslinking crude silicone rubber.

In accordance with the invention, the individual silicone rubber structures based on the crude silicone rubber contain a crosslinking catalyst.

In accordance with a concomitant feature of the invention, the article is a pencil-like writing implement, and the silicone rubber structures are disposed at least on a subregion of a surface of the pencil-like writing implement.

Other features which are considered as characteristic for the invention are set forth in the appended claims.

Although the invention is illustrated and described herein as embodied in an article having a grip zone which serves for handling, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a diagrammatic, right-side view of a writing instrument according to the invention.

### DETAILED DESCRIPTION OF THE INVENTION

In one particularly preferred operative example, the structures are composed of a UV-crosslinked silicone rubber. A silicone rubber of this kind, which can be produced from a UV-crosslinkable crude silicone rubber, has the advantage that the crude silicone rubber, applied initially in fluid form, crosslinks at room temperature under UV irradiation. No subsequent drying is necessary. It is therefore suitable in particular for writing implements having temperature-sensitive cores, cosmetic cores for example. Moreover there is no drying phase needed, which simplifies the process regime and shortens the production time. The UV crosslinking may take place free-radically, in the case of silicone acrylates, for example, or else ionically, in the case of epoxy silicones, for example.

In many cases, increased crosslinking temperatures, which normally span a temperature range from around 100° C. to 200° C., do not play any part. Preference is given to articles with structures containing silicone rubber crosslinked with oxysilane, more particularly based on polydimethylsiloxane. Acetoxysilane has emerged as being particularly advantageous as a crosslinker (Example 1). One such material is available, for example, from Wacker Chemie GmbH, D-81737 Munich, under the tradename ELASTOSIL N10. The fluid, crude silicone rubber is applied, for example, via nozzles or by screen printing (screen with square meshes approximately 1 mm² in size) in the form of pimples to the grip zone of an article, such as a ballpoint pen with an ABS shaft, for example, and crosslinked by a thermal treatment at approximately 170° C. The thermal treatment may be performed with the aid of brief infrared irradiation. Such a treatment reduces the thermal load on the article, something which is appropriate more particularly in the case of writing implements having temperature-sensitive cores.

In addition, a silicone rubber with oximosilane, more particularly butane-2-one oxime, as the crosslinker and with the abovementioned polydimethylsiloxane has proven particularly advantageous (Example 2). One such material is available, for example, from Drawin Vertriebs GmbH, D-85521 Ottobrunn. With a crude silicone rubber of this kind it is possible to add Rhenol paste (Cariant AG) with a fraction of 1% by weight for the purpose of coloring. The paste is mixed homogeneously with the crude silicone rubber in a stirrer mechanism at a mild temperature, up to 40° C. at most. Thereafter the resulting composition is applied by screen printing, using wide-mesh screens, in the form of ribs to brush handles and handles of table-tennis paddles. As in the case of example 1, a brief thermal treatment crosslinks the crude silicone rubber.

Goldschmidt GmbH of D-45116 Essen sells UV-crosslinkable crude silicone rubbers envisioned for the production of partable adhesive coatings on articles such as sticky notes, labels, etc. It has surprisingly been found that they can be used to produce very soft and grippy raised structures with high adhesion and extremely pleasant tactility on a multiplicity of very different materials. Examples of suitable formulas in this context include the following:

Starting from the crude silicone rubber products TEGO RC 902 and RC 706, in each case with admixture of TEGO RC 711 and a photoinitiator (TEGO A 17), mixtures are produced, the respective starting compositions being able to be applied, with the aid of nozzles, in pimple form to an article. Application takes place under an inert gas atmosphere, such as under nitrogen, for example.

### EXAMPLE 3

| | | |
|---|---|---|
| TEGO RC 902 | 65% | by weight |
| TEGO RC 711 | 30% | by weight |
| TEGO A 17 | 1.5% | by weight |
| TEGO RC 1772 (matting agent) | 3.5% | by weight |

### EXAMPLE 4

| | | |
|---|---|---|
| TEGO RC 706 | 30% | by weight |
| TEGO RC 711 | 68% | by weight |
| TEGO A 17 | 2% | by weight |

One version which is advantageous in particular from a technical standpoint contains articles with structures based on at least one crude silicone rubber dispersion. Not only peroxide-crosslinking dispersions but also addition-crosslinking dispersions are conceivable in this context. In this case, as also in the case of crude silicone rubber not present as a dispersion, a catalyst is appropriate to accelerate crosslinking. In the case of the stated dispersions, acceleration may take place by use of small amounts of platinum.

In all of the examples indicated it is possible to add fillers, colorants, and—if appropriate—additives. The surfaces of the articles may where appropriate be enhanced by a corona or plasma treatment or by flaming in order to achieve greater adhesion, as may be the case, for instance, with articles that are subject to severe exposure.

Referring now to the single FIGURE of the drawing in detail, there is shown, as an example of an article, a wood-encased pencil 2 which has a writing core 1 and a hexagonal cross-sectional shape. Applied to the lacquered surface 3 of the pencil are individual grip pimples 4 formed of a silicone material of the type described above. Application takes place, for example, with the aid of nozzles, the silicone material being fluid at the time of application and subsequently undergoing solidification.

1. An article, comprising:
a grip zone having a surface and serving for handling; and
individual silicone rubber structures, at least part of said surface of said grip zone bearing said individual silicone rubber structures formed as separate parts and projecting from said surface.

2. The article according to claim 1, wherein said individual silicone rubber structures are composed of a UV-crosslinked silicone rubber.

3. The article according to claim 1, wherein said individual silicone rubber structures are composed of a silicone rubber crosslinked with oxysilane.

4. The article according to claim 3, wherein said silicone rubber contains polydimethylsiloxane crosslinked via acetoxysilane.

5. The article according to claim 1, wherein said individual silicone rubber structures are composed of a silicone rubber crosslinked with oximosilane.

6. The article according to claim 5, wherein said silicone rubber contains poly-dimethylsiloxane crosslinked via butan-2-one oxime.

7. The article according to claim 1, wherein said individual silicone rubber structures are formed from crude silicone rubber dispersions.

8. The article according to claim 7, wherein said silicone rubber dispersions are selected from the group consisting of a peroxide-crosslinking crude silicone rubber and a platinum-crosslinking crude silicone rubber.

9. The article according to claim 7, wherein said individual silicone rubber structures based on said crude silicone rubber contain a crosslinking catalyst.

10. The article according to claim 1, wherein the article is a pencil-like writing implement, and said silicone rubber structures are disposed at least on a subregion of a surface of said pencil-like writing implement.
